(19) United States
(12) Patent Application Publication
(10) Pub. No.: US 2010/0205040 A1
(43) Pub. Date: Aug. 12, 2010

(54) METHOD FOR PROVIDING AND DISPLAYING POLITICAL CAMPAIGN INFORMATION

(76) Inventor: Ryan M. Wiederstein, Cumming, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/369,892

(22) Filed: Feb. 12, 2009

(51) Int. Cl. G06Q 10/00; G06Q 50/00

(52) U.S. Cl. 705/10

(57) ABSTRACT

A method for providing and displaying information for a political campaign. The method includes the steps of collecting data from real property information, individual information, and political information and inputting the collected data into a database in a computer. Also included are the steps of determining a set of characteristics for a political action objective, cross-referencing the set of characteristics with the collected data in the database to create a shape, and displaying the shape. The method includes the final step of creating a plan of action based upon an analysis of the shape.

### BACKGROUND OF THE INVENTION

This invention relates to a system for analyzing demographics to optimize a strategy of campaigning for an election. More specifically, this invention relates to an apparatus and method which uses personal, residential, and political data in combination with geospatial mapping to generate maps and data in order to formulate a plan of action to achieve a particular political objective.

Conducting a successful political campaign can be characterized as difficult, if not impossible, based upon the ever changing socio-political atmosphere of the various political subdivisions of a nation. Oftentimes elections seem to be won or lost based largely upon intangible and unpredictable factors, such as the public's perception of the economy or the effectiveness of the current political regime in place during a given period. Nonetheless, despite the unpredictable nature of factors that influence elections, voter demographics have long been used by candidates to target individuals likely to support the candidate and generate the money, volunteers, and ultimately, votes needed to win an election. Furthermore, with the greater accessibility of demographic data through sources such as the internet, more information is available to better target voters, supporters, financial contributors and volunteers. However, despite the greater accessibility of information provided by the internet, presently voter demographic data is limited to analyzing voting districts as a whole.

The present methods of analyzing and mapping voter demographic data exhibit numerous inadequacies. Primarily, analyzing data on a district wide level is simply too general a basis and is of limited value for effectively conducting important campaigning activities such as door to door campaigning and identifying specific residences for sign placement, targeted mailings, and requests for campaign contributions. Because the present demographic data is not associated with a specific parcel, the above campaigning activities are characterized by imprecision and guesswork, leading to wasted time, money, and resources, all of which being valuable but limited resources in a political election. A further disadvantage faced by individuals conducting political campaigns is that the available demographic data is outdated and inaccurate, leading to additional wasted resources. Therefore a need in the art exists for a product and method that provides precise, parcel-specific data that is updated and current for effectively conducting important campaigning activities such as door to door campaigning and identifying specific residences for sign placement, targeted mailings, identifying volunteers and requests for campaign contributions.

Therefore, it is a principal object of this invention to provide precise, parcel-specific or household data for more effectively conducting important campaigning activities such as door to door campaigning and identifying specific constituents for sign placement, targeted mailings, and requests for campaign contributions.

Yet another object of the present invention is to provide data that is updated and current.

A further object of the present invention is to provide an apparatus and method which uses personal, residential, and political data in combination with geospatial mapping to generate maps and data in order to formulate a plan of action to achieve a particular political objective.

These and other objects, features or advantages of the present invention will become apparent from the specification and claims.

### BRIEF SUMMARY OF THE INVENTION

A method for providing and displaying information for a political campaign. The method includes the steps of collecting data from real property information, individual information, and political information and inputting, importing and integrating the collected data into a database in a computer. Also included in the method are the steps of determining a set of characteristics for a political action objective, cross-referencing the set of characteristics with the collected data in the database to create a shape, and displaying the shape. The method includes the final step of creating a plan of action based upon an analysis of the shape. In this manner the method provides precise, parcel-specific data for more effectively conducting important campaigning activities.

### BRIEF DESCRIPTION OF THE DRAWINGS

FIG. 1 is a schematic diagram of a system for formulating a plan of action; and

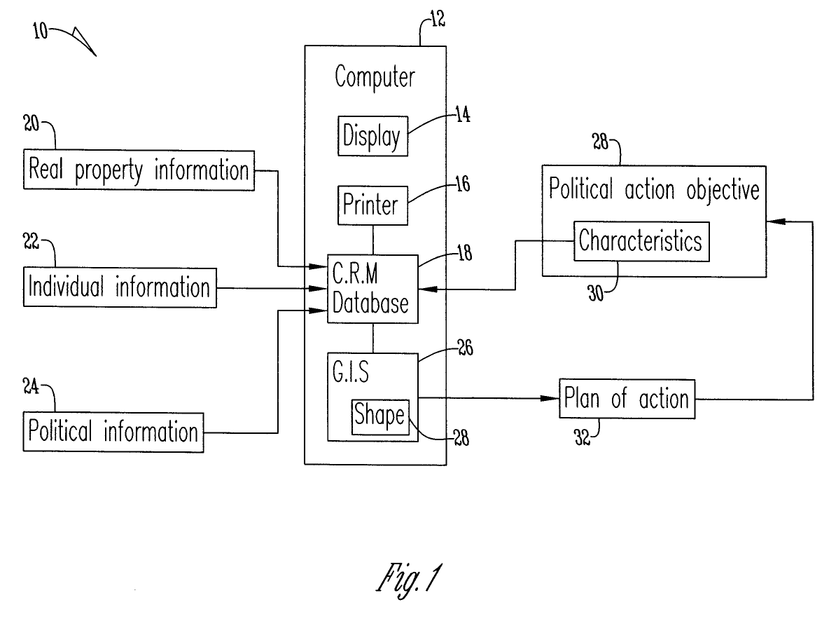

FIG. 2 is a flow chart of a method used for formulating a plan of action using the system of FIG. 1.

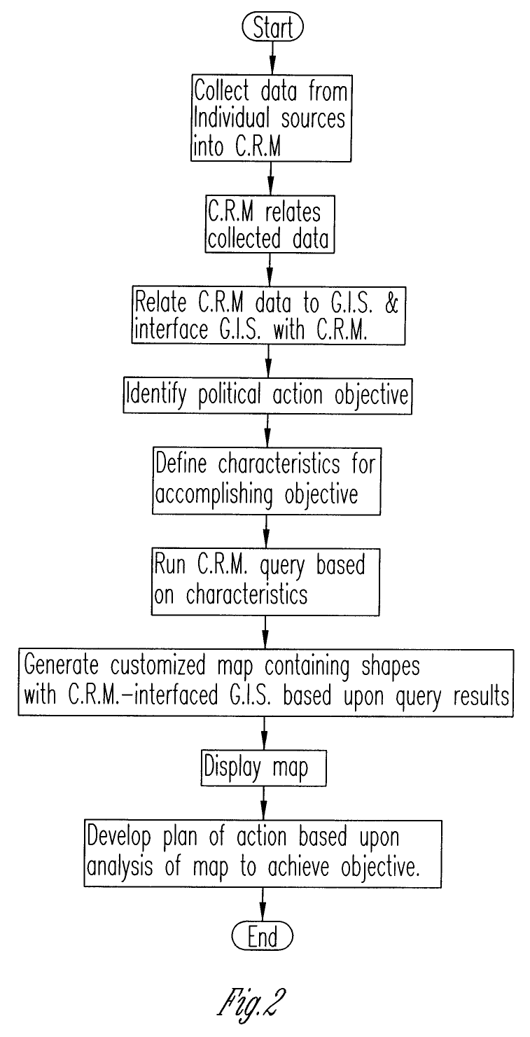

### DETAILED DESCRIPTION OF THE PREFERRED EMBODIMENT

Referring to the figures, the apparatus and method 10 includes a computer 12 having a display 14, a printer 16 and a database 18. One of ordinary skill in the art will appreciate that computer 12 includes additional features not shown in the drawings, such as RAM, microprocessors, and the ability to connect to a server, other computers, and an electronic network through any means presently known in the art. In one embodiment, the database 18 is a contact relationship management (CRM) system, a relational database system and interface capable of collecting and receiving data from various data sources in addition to tracking and updating data manually and automatically through the electric network.

The CRM database 18 receives data from a variety of sources, including but not limited to sources providing real property information 20, individual information 22, and political information 24. Depending upon the origin and quality of the information, there not only may exist some overlap between the data listings between one type of information and another, but also the different types of information may include many or few data entries depending upon the availability of the information. In one embodiment, an example of real property information 20 includes the address of the real property, the owner, market value, tax value, sales value, equity value, judgments or liens levied upon the real property, polling data for the residence, and the political subdivision/precinct/district of the real property. Examples of individual information 22 include the name of an individual, the individual's address, date of birth, marital status, legal record, number of children, financial status, race, phone number, email, political affiliation, socioeconomic status and income. Further examples of individual information 20 include state medical board records and other state and/or federal provided records which provide information regarding health professionals and any other professionals licensed by the state or federal government, and sex offender records, including the current address of sex offenders. Examples of political information 24 include names of individuals who are financial contributors, volunteers, polling data, an individual's voting precinct, party affiliation, voting frequency, voting record, and prior election results for the political subdivision of the individual. Additional examples of political information 24 include information from political action & political affiliated committees, event planners, campaign ethics and disclosure boards, and county auditors; all of which providing a variety of politically-oriented information such as prior year election results by political subdivision and additional information on political contributors and volunteers. Yet another example of political information 24 includes demographic data, including the political and socio-economic status of residents, and polling data/registered voter information, including information about the address, voting precinct, frequency, tendency to vote for a particular election (primary, special, general, etc.) and absentee voter information.

Also included in computer 12 is a graphical information system (GIS) 26. The GIS 26 can either be a commercially available or custom built system that is capable integrating the data of the CRM database 18 and relating a shape 28 of a parcel and symbology to a corresponding record in the CRM database 18. In addition, the GIS 26 contains a variety of geospatial information, including but not limited to: geospatial parcel information, parcel zoning and class type (apartment, office, retail, industrial, etc); geospatial zoning information (current and future improvements with relative improvement data); geospatial polling location, precinct, district, city, county, schools, churches with affiliation, hospitals, trails, parks; streets and highways with any degree of detail desired; traffic loads on all streets, stoplight/sign locations; drive time determination and network routing methodology; corporate boundaries; airports; bodies of water; recreation areas; eco-sensitive areas; prior voting patterns by political subdivision; natural disaster information; crime data; union membership demographic information; and historic districts; all of which are capable of being related to the data of a CRM database 18 and displayed in a customized map incorporating the geospatial information and the data of the CRM database 18 which can be displayed on display 14 of computer 12 or printed by printer 16.

A political action objective 28 is also included along with a set of characteristics 30 designed to further the political action objective 28. Depending upon the strategy adopted by a particular campaign, a political candidate can have a variety of political action objectives. Examples of political action objectives include door to door campaigning by supporters and/or the candidate, yard sign distribution, meetings (neighborhood meetings, fraternal organization gatherings, open houses, generating campaign volunteers, fund raising events, “meet the candidate(s) events,” etc.), distributing absentee ballots to voters, registration efforts for non-registered voters, calling voters asking for support, votes, generating campaign contributions, disseminating political information (by carrier mail, email, online community forums, etc.), and calling voters asking survey-type questions regarding what issues are important to them. Most often, each political action objective 28 will have its own unique set of characteristics 30 which defines the target audience of the political action objective 28. For example, if a candidate's political action objective 28 is generating campaign contributions, the characteristics 30 that would define the target audience would be individuals who share the same party affiliation as the candidate, have a consistent voting record, have contributed to campaigns in the past, and have an income above a certain level. As another illustration, a candidate having a political action objective 28 of distributing yard signs to achieve maximum placement and visibility would select target audience characteristics 30 such as same party affiliation, consistent voting record, and residences that lie along high traffic streets.

In operation, data is collected from individual sources, including but not limited to sources providing real property information 20, individual information 22, and political information 24. In one embodiment, real property information 20, individual information 22, and political information 24 are contained in separate database tables. The data from the individual sources is collected and integrated into a single CRM database 18, and each separate entry in the information from the separate sources is combined into a common CRM database 18 entry with information derived from each separate source. This is accomplished by relating or linking consistent fields from different data sources together to create one CRM database 18 field containing all information from each source that applies to a particular individual or residence. For example, records are related by linking or associating one or more common fields in separate sources together in a CRM, such as listings having the same entries for the “First Name,” “Last Name, “House Number,” and “Street Name” fields.

The CRM database 18 with its related records is additionally linked or integrated with the GIS 26. The GIS 26 is able to produce a shape that corresponds to the data of the CRM database 18 by relating GIS information to unique identifier(s) within a CRM database. One way this is accomplished is by including a primary key, such as a GeoParcel ID, a District Parcel ID, or x/y coordinates, in the metadata of a CRM database listing that matches up to a corresponding GIS shape. Yet another way to relate the corresponding GIS shape to a CRM database listing is to employ the same process described above, by aligning database fields with the same data fields assigned to a particular shape.

The CRM database 18 and GIS 26, linked directly or by an application programming interface (API)/API equivalent, are used to interface with a user of the computer 12, which provides the user with one record for every individual in a voting region. Once the fields are related or linked into the CRM database 18, the CRM database 18 is capable of accessing all database tables and running queries to produce sorted data based upon the characteristics 30 selected to define a target audience within the voting region, and the GIS 26 is capable of generating customized maps based upon the characteristics 30 selected to achieve a political action objective 28 and thus provide the candidate with a customized plan of action 32 based upon analysis of the map. For example, as disclosed above, a Democrat candidate having a political action objective 28 of distributing yard signs to achieve maximum placement and visibility would run a CRM database 18 query directing the database to output characteristics 30 such as residents within the candidate's district that are Democrats, have voted in the last 3 elections (for example), and live in a residences that lie along high traffic streets. Owing to the interface between the CRM database 18 and the GIS 26, each corresponding record produced by the CRM database 18 query would relate to an individual GIS 26 shape (via the primary key metadata or other means described above) with the GIS 26 producing a map displaying every residence embodying the characteristics 30 tailored to a particular political action objective 28, e.g., mapping the location of every individual residence within the voting region that is identified within the CRM as a democrat, has voted in the last 3 elections, and lives on a high traffic street. Analysis of the map therefore provides the candidate with a plan of action 32 to achieve the political action objective 28; as described in the preceding example, the map displays every voting Democrat having a residence on a high traffic street. With this information, a candidate is able to develop the plan of action 32 of strategically contacting only those individual residences shown on the map to be likely to both agree to have the candidate's sign placed in their yard and generate the greatest degree of visibility once the signs are placed. As will be appreciated by those skilled in the art, this plan of action 32 is much more effective than either contacting individuals listed on a printout who may live in a cul-de-sac with low traffic visibility (or own a townhome with covenants that prohibit political signage), or identifying individuals who have residences along high traffic streets who may not be receptive to the candidate's party affiliation. One skilled in the art will recognize that customized maps generated by the GIS 26 interface with a CRM database 18 query can be used to formulate a variety of additional plans of action 32 to achieve political objectives 28. As a further example, a candidate wishing to achieve the political objective 28 of capturing additional undecided or “swing” votes can develop a plan of action 32 by running a CRM database 18 query for voters registered as “independent” and utilizing the corresponding GIS 26 generated map to identify and contact those residences by phone or door to door campaigning.

One having ordinary skill in the art will appreciate that in addition to mapping shapes of parcels found in CRM database 18 listings, GIS 26 is also capable of assigning particular symbols to particular categories of CRM database 18 listings selected by a user, such as assigning every residence/parcel having the designation of being a “Democrat” within the CRM database 18 with a blue dot and assigning every residence/parcel having the designation of being a “Republican” with a red dot, and displaying the results on a map alone or in combination with other characteristic 30 designations. Furthermore, those skilled in the art will understand that based upon selection of characteristics 30 such as political subdivision (state, district, precinct, etc.), the GIS 26 used in combination with the CRM database 18 can produce displays for any political subdivision for which the user has data. Therefore, the foregoing system describes how method for providing and displaying information for a political campaign that successfully enables a candidate to create a plan of action to meet a political action objective for a campaign as small as a school board election or as large as a presidential campaign.

Accordingly, a system and method have been described that, at the very least, meet the stated objectives.

1. A method for providing and displaying information for a political campaign, comprising the steps of:
collecting data from real property information, individual information, and political information;
integrating collected data into a database in a computer;
determining a set of characteristics for a political action objective;
cross-referencing the set of characteristics with the collected data in the database to create a shape;
displaying the shape; and
creating a plan of action based upon an analysis of the shape.

2. The method for providing and displaying information for a political campaign of claim 1, wherein real property information comprises the address of the real property, owner of real property, market value of real property, tax value of real property, sales value of real property, equity value of real property, judgments or liens levied upon real property, polling data for the residence, and political subdivision/precinct/district of the real property.

3. The method for providing and displaying information for a political campaign of claim 1, wherein individual information comprises the name of an individual, the individual's address, date of birth, marital status, legal record, number of children, financial status, race, phone number, email, political affiliation, socio-economic status and income.

4. The method for providing and displaying information for a political campaign of claim 1, wherein political information comprises names of individuals who are financial contributors, volunteers, polling data, an individual's voting precinct, party affiliation, voting frequency, voting record, and prior election results for the political subdivision of the individual.

5. The method for providing and displaying information for a political campaign of claim 1, wherein the political action objective is placement and visibility of campaign signs.

6. The method for providing and displaying information for a political campaign of claim 5 wherein determining the set of characteristics comprises identifying individuals within a geographic area having similar real property information, individual information, and political information.

7. The method for providing and displaying information for a political campaign of claim 1, wherein the political action objective is generating campaign contributions.

8. The method for providing and displaying information for a political campaign of claim 7 wherein determining the set of characteristics comprises identifying individuals within a geographic area having similar real property information, individual information, and political information.

9. The method for providing and displaying information for a political campaign of claim 1, wherein the political action objective is generating campaign volunteers.

10. The method for providing and displaying information for a political campaign of claim 9 wherein determining the set of characteristics comprises identifying individuals within a geographic area having similar real property information, individual information, and political information.

11. The method for providing and displaying information for a political campaign of claim 1, wherein the political action objective is door to door campaigning.

12. The method for providing and displaying information for a political campaign of claim 11 wherein determining the set of characteristics comprises identifying individuals within a geographic area having similar real property information, individual information, and political information.

13. The method for providing and displaying information for a political campaign of claim 1, wherein the political action objective is disseminating political information.

14. The method for providing and displaying information for a political campaign of claim 13 wherein determining the set of characteristics comprises identifying individuals within a geographic area having similar real property information, individual information, and political information.

15. The method for providing and displaying information for a political campaign of claim 13 wherein disseminating political information is by mail.

16. The method for providing and displaying information for a political campaign of claim 13 wherein disseminating political information is by Internet communication.

17. The method for providing and displaying information for a political campaign of claim 1 wherein the shape is displayed on a map.

18. The method for providing and displaying information for a political campaign of claim 1 further comprising the step of providing a contact management database that verifies and updates the real property information, individual information, and political information.

19. The method for providing and displaying information for a political campaign of claim 1 wherein the plan of action is targeting a plurality of single residences to achieve the political action objective.
